(19) United States
(12) Patent Application Publication
(10) Pub. No.: US 2012/0283000 A1
(43) Pub. Date: Nov. 8, 2012

(54) SYSTEM AND METHOD FOR TRADING TOURNAMENTS

(75) Inventor: Olexandr Volkov, Melitopol (UA)

(73) Assignee: EMEMCIS LLC

(21) Appl. No.: 13/460,838

(22) Filed: May 1, 2012

Related U.S. Application Data
(60) Provisional application No. 61/518,456, filed on May 4, 2011.

(51) Int. Cl. A63F 13/12

(52) U.S. Cl. 463/25; 463/42

(57) ABSTRACT

A mechanisms is provided for adding a tournament to a platform not intended to have a tournament. In at least one embodiment, the tournament may be a competition in trading on a foreign currency exchange.

### CROSS REFERENCE TO RELATED APPLICATION

This application claims priority benefit of U.S. Provisional Patent Application 61/626,485 entitled, SECURING TRANSACTIONS AGAINST CYBERATTACKS SYSTEM AND METHOD FOR TRADING TOURNAMENTS, by Olexandr Volkov, filed May 4, 2011, the entire contents of which are incorporated herein by reference; the entire contents of which are incorporated herein by reference.

### FIELD OF THE INVENTION

The present specification relates to network based trading tournaments.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The foreign exchange market (Forex, FX, or currency market) is a worldwide-decentralized over-the-counter financial market for the trading of currencies. Financial centers around the world facilitate trading between a wide range of different types of buyers and sellers around the clock, with the exception of weekends. The foreign exchange market determines the relative values of different currencies.

The primary purpose of the foreign exchange is to assist international trade and investment, by allowing businesses to convert one currency to another currency. For example, the Forex permits a US business to import British goods and pay Pound Sterling, even though the business's income is in US dollars. Forex also supports speculative trading that attempts to profit from the rise or decline of the relative values of currencies.

MetaTrader4, or MT4, is a software program or electronic trading platform widely used by online Forex (foreign exchange, i.e. currency) speculative traders. Although in this specification, the electronic trading platform is MT4, the invention is not limited to the use of MT4. Throughout the specification, any electronic trading platform may be substituted for MT4, and MT4 is just used as one example of an electronic trading system with which the invention maybe used. In finance, an electronic trading platform is a computer system that can be used to place orders for financial products, such as shares, bonds, currencies, commodities and derivatives with a financial intermediary, such as a brokers, market makers, or stock exchanges over a network. Such platforms allow electronic trading to be carried out by users from any location with a client terminal (e.g., computer, smart phone, mobile device, etc.), which may be used instead of traditional floor trading and telephone based trading. Electronic trading platforms typically stream current market prices on which users can trade and may provide additional trading tools, such as charting packages, news feeds and account management functions.

### BRIEF DESCRIPTION OF THE DRAWINGS

In the following drawings like reference, numbers are used to refer to like elements. Although the following figures depict various examples of the invention, the invention is not limited to the examples depicted in the figures.

FIG. 1A shows diagram of an embodiment of a system of trading tournaments;

FIG. 1B shows a block diagram of an embodiment of a system implementing network based trading tournaments;

FIG. 1C is a schematic depiction of an example of the tournament gaming process.

FIG. 2 shows a table of an example of prize fund formation;

FIG. 3 is a block diagram of an embodiment of a device for implementing embodiments of network based trading tournaments;

FIG. 4 shows a flow diagram of an embodiment of a game server side method of trading tournament;

FIG. 5 shows a flow diagram of an embodiment of a trading server side method of trading tournament;

FIG. 6 shows a flow diagram of an embodiment of a player system-side method of trading tournament.

### DETAILED DESCRIPTION

Although various embodiments of the invention may have been motivated by various deficiencies with the prior art, which may be discussed or alluded to in one or more places in the specification, embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies. In accordance with embodiments, there are mechanisms provided for methods and systems for network based trading tournaments, and more particularly, for conducting online financial trading competitions between authorized players within the framework of a particular financial instrument or market (e.g., bonds, stocks, Forex, other investment securities, etc.) on a trading platform.

In accordance with embodiments, mechanisms are provided for network based trading tournaments, and more particularly, for conducting online financial trading competitions between authorized players within the framework of a particular financial instrument on a trading platform. In this specification, the word device may be a user device or terminal, a mobile device or terminal, a mobile phone, a laptop, handheld computer, computer pad (e.g., an Ipad®), another mobile device, personal computer, or other device. A problem that exists with providing a trading tournament in a Forex environment is that that financial trading platform is not designed for running tournaments, and consequently using a forex platform for tournament is problematic.

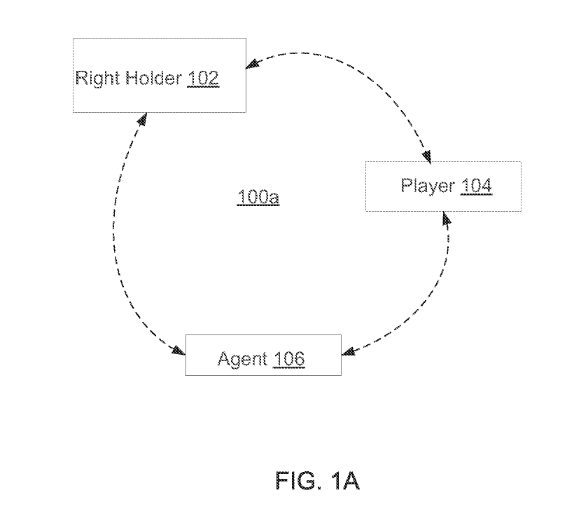

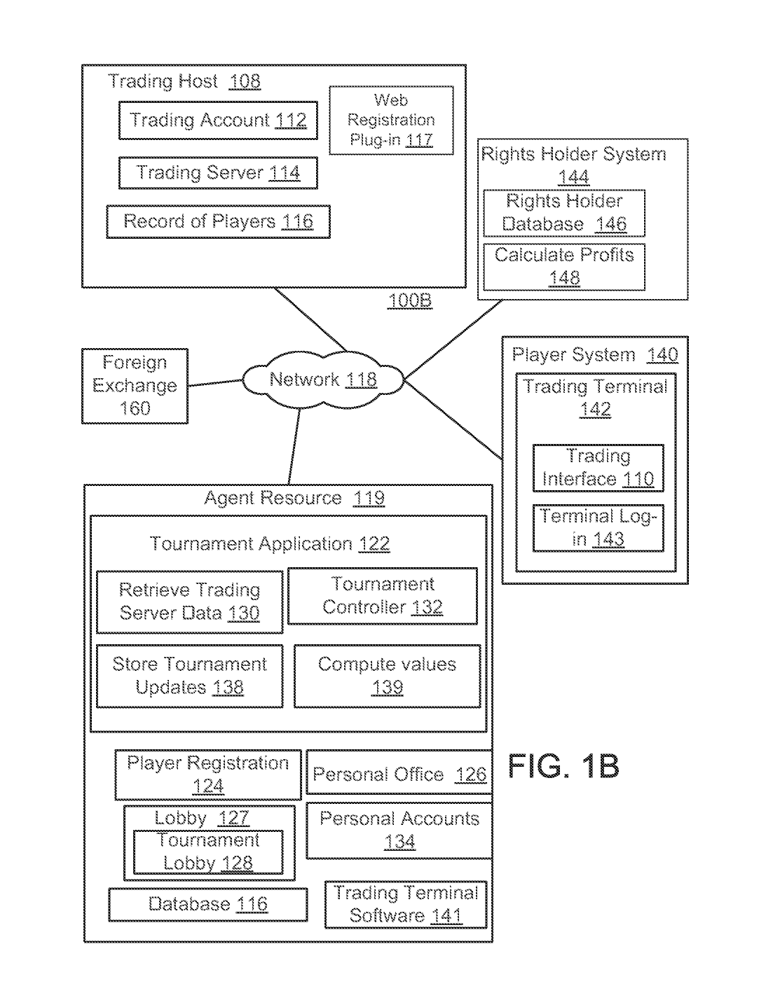

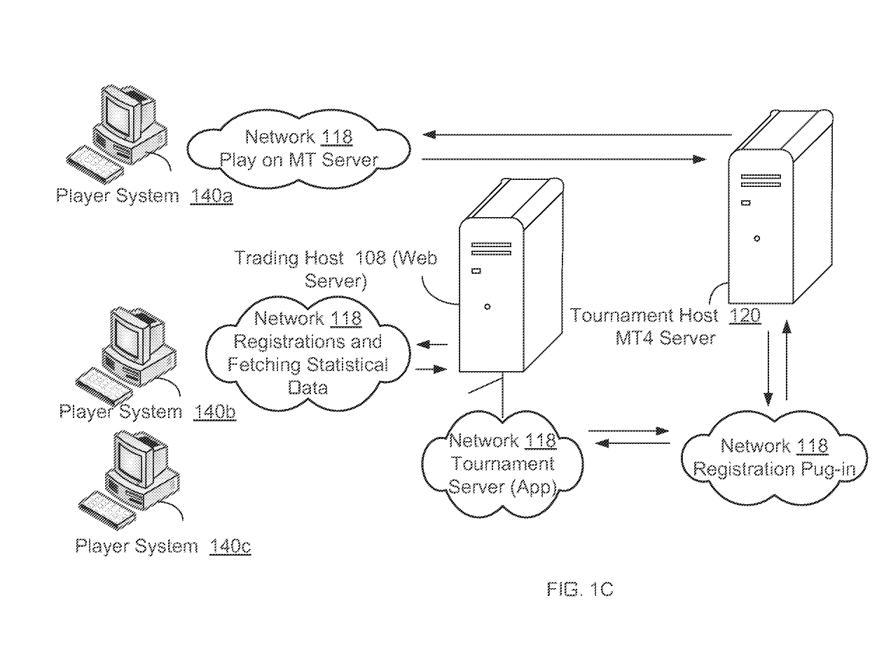

FIG. 1A shows diagram of an embodiment of a system 100a for trading tournaments. The system 100a may include right holder 102, player 104, and agent 106. In other embodiments, system 100a may not include all of the elements listed above and/or may include other elements in addition to and/or instead of those listed.

FIG. 1A shows the various entities that may participate in a Forex tournament system and their relationships to one another. The arrows show which entities are related to, and/or communicate with, one another. In at least one embodiment, a right holder 102 may be an owner of a company, which may distribute and/or deploy the investment tournaments. The right holder 102 may have exclusive rights on the technology for carrying out the investment tournaments. Right holder 102 may establish the rules and characteristics for holding an investment tournament, may establish the visual design of the graphical user interfaces (GUI) of the tournament interface, and may provide tools for managing the collection and processing of statistical data of the players' investments, for example.

In at least one embodiment, player 104 is the one of the players that plays the tournament, and player 104 may also be referred to as a tournament player. Player 104 may also be a Forex trader that trades various currencies on behalf of player 104 and/or others. The player 104 may participate in the Forex tournament. Player 104 may compete for prizes or monetary rewards, where the size or value of the prize awarded to a player may be based on the player's final ranking or the player's final placement in the tournament.

Agent 106 may be an individual or a legal entity that purchases or leases the rights to use the technology owned by right holder 102 in order to organize the Forex tournaments on the website of agent 106 or elsewhere. Agent 106 may provide the players an opportunity to take part in the tournament and may send statistical data about the Forex tournament to the right holder's database, so that right holder 102 and agent 106 may share profits.

In at least one embodiment, the software for the tournament may be supplied to an agent 106 by right holder 102. Agent 106 may optionally use the software and may be free in developing their own algorithms for the distribution of prizes and funds collected during the tournament. In another embodiment, right holder 102 leases or rents the rights to hold an investment tournament and/or the corresponding contest technology platform (GUI, trading resources, database, registration, billing, etc.) to an agent (e.g., agent 106). In at least one embodiment, right holder 102 integrates the—platform on which the tournament takes place with the agent resources and agent databases for a unified registration of tournament players on the agent resources and provides a unified system of money movement for the agent and contest players' accounts.

### Tournament

Forex tournament is an online contest for Forex trading via MetaTrader 4 or similar trading terminals. In at least one embodiment, the tournament may include collecting players' contributions, formation of a prize fund from the collection, playing the tournament and finally distributing prize money amongst the winners of the tournament. The winners may be determined by the highest rate of profit added to an initial deposit of funds, resulting from trading in the Forex market on an account for a certain time period and with currencies traded depending on the tournament type. In another embodiment, a Forex tournament may be held where players participate without a contribution, and a tournament of this type may be referred to as a “Freeroll” tournament. The prize fund may be provided by the agent 106. The agent 106 may hold a Freeroll for promoting the Forex tournaments.

In a Forex system and in the tournament currencies are traded against one another. However, in the tournament, optionally the transactions may be simulated transactions in which no actual currency is necessarily traded. Each currency pair may constitute an individual trading product and is traditionally noted XXXYYY or XXX/YYY, where XXX and YYY are the ISO 4217 international three-letter code of the currencies involved. The first currency (XXX) is the base currency that is quoted relative to the second currency (YYY), called the counter currency (or quote currency). For instance, in the quotation EURUSD (EUR/USD) 1.5465 is the price of the euro expressed in US dollars (USD), meaning 1 euro=1.5465 dollars. The market convention is to quote most exchange rates against the USD with the US dollar as the base currency (e.g. USDJPY, USDCAD, and USDCHF). The exceptions are the British pound (GBP), Australian dollar (AUD), the New Zealand dollar (NZD) and the euro (EUR) where the USD is the counter currency and the British pound (GBP), Australian dollar (AUD), the New Zealand dollar (NZD) or the euro (EUR), respectively, is the base currency (e.g., which is written as GBPUSD, AUDUSD, NZDUSD, or EURUSD).

Fluctuations in exchange rates are usually caused by actual monetary flows as well as by expectations of changes in monetary flows caused by changes in gross domestic product (GDP) growth, inflation, budget and trade deficits or surpluses, large cross-border mergers and acquisition deals, and/or other macroeconomic conditions and/or events.

In at least one embodiment, an agent 106 and/or right holder 102 may realize a profit by charging a fee that is a greater than the amount of money distributed in prizes. For example, the prize fund may be a percentage of the sum of the player entry fees. For example, an agent 106 may take a commission, for example ten percent (10%) of the fees collected, to pay for operating expenses and fees due to the right holder 102, with any remaining portion going to the user/agent 106 as a profit. The balance of the prize fund, which in this example is ninety percent (90%), may be distributed to the tournament players. In at least some embodiments, the right holder 102 may receive a certain percentage of profits from the agent 106 under an agreement for conveying rights for conducting investment tournaments. In at least one embodiment, the agent 106 may receive a certain commission from the entry fee or prize fund and the right holder 102 may receive a certain commission from the agent's commission. In an example, if the agent commission is ten percent (10%) of the entry fee, and the right holder's commission is 10% of the agent fee, the right holder 102 is entitled to one percent of the entry fee. In at least some embodiments, the agent 106 may be responsible for all withdrawals and processing of payments from and to the players of the tournaments, while the right holder 102 may not necessarily be engaged in any direct relationship with the players of the tournaments.

In at least one embodiment, tournaments may differ from one another by having different durations and/or frequency of the tournament for example, hourly, daily, weekly, and monthly. Some tournaments may operate on different investment instruments, such as different currency pairs—EUR/USD, GPB/JPY, USD/JPY. In another embodiment, tournaments may impose limitations on players including, limiting the use of expert advisors, the maximum amount of trading operations performed on an account, the trading instruments that may be used, and/or the number of currency pairs, etc.

In at least one embodiment, there may be many different types of trading tournaments, each differing in the features for the tournament from the other types of trading tournaments. In at least one embodiment, players invest a base sum of money in financial instruments, and make trades in an attempt to realize the highest rate of return, while trying to avoid investment losses. For example in at least one embodiment, the players utilize an account funded with a base sum for trading on the Forex market for a predefined period.

In at least one embodiment, player 104 receives a login and password to a new trading account upon signing up to play a tournament. The trading account may be a virtual trading account where the player performs Forex trading operations, and the percentage and/or amount of virtual profits earned by each player may be used to determine the winner of the tournament. The trading account may not necessarily be the account where all of the operations with real money are conducted, but may be an account that does not have any actual money, which just simulates the results had an actual trade taken place according on the player's instructions.

For example, in an embodiment, the trades are real and the trades exist on trading server. However, if you look at the trades and transactions from the point of view of the logic of the tournament application, and the trades are demo trades. In the current embodiment, the only difference between demo trades and actual trades is that demo trades occur via a demo account, or via a demo trading server, and actual trades occur via an actual account on an non-demo trading server. To elaborate, there is an account on the trading server, and the trades and actions related to making the trades (i.e. the logic applied to all trades on the Foreign Exchange) are virtual, which is due to the fact that the trades occur on an account that is a demo account, or a trading server that is a demo trading server.

Player 104 may add funds to the player's personal account for paying for participation in the contests that player 104 later plans to participate in (in the hope of receiving the rewards in case player 104 wins). In an example, player 104 may be a Forex trader. The trading results may be viewable in a special trading account (e.g., in MetaTrader4 or analogous platform), where the trading account uses virtual money. The winners' rankings may be shown with the trading results.

The final ranking of player 104 may be based on the player's rate of return on a base sum of money or may be based on the player's final total sum of investment gains, where the base sum of money may be provided upon payment of an entry fee that a player pays to enter the competition.

The grand prize winner may have earned the highest percentage of profit among all the players of the tournament. Although the exact formula for determining each successive winner may vary, in general players whose trades would have earned a higher percentage of money, had the trades been real, will have a higher ranking in the game.

For example, when each of the players signs up for a tournament, each player receives a tournament account with an opening balance of the equivalent of $10,000 USD in the form of virtual money. Subsequently, each of the players performs trading operations in the Forex market, via MetaTrader4 or an equivalent trading platform, utilizing the virtual money in their trading account for a specified period of time (the length of the tournament may be varied−e.g., 1 hour, 1 day, 1 week, 1 month). At the conclusion of the tournament, each of the players have trading results on their individual virtual trading account. Suppose, one of the players has earned a return of 119% of profit on their trading account, a second player earns 40% on his trades, a third player earns 0% on his profits, a fourth player lost 30% of the initial virtual deposit, a fifth player lost 40% of the initial virtual deposit. In this case, the grand prize may be awarded to the first player who earned the highest virtual profit on his account. If the total number of prize winners is 4 (in this example), then players 1 through 4 will receive prizes (where the prizes awards are real money calculated as share of the prize fund).

FIG. 1B shows an embodiment of a block diagram of system 100b, a system of Forex trading tournaments. System 100b may include trading host 108, which may include trading account 112, trading server 114, records of players 116, and web registration plug-in 117. System 100b may also include network 118 and agent resource 119, which in-turn may include lobby 127, tournament lobby 128, agent resource 119, player registration 124, database 129, retrieve trading server data 130, tournament controller 132, personal accounts 134, store tournament updates 138, and compute values 139. System 100b may also include player system 140, trading terminal software 141, which in turn may include trading terminal 142, terminal log-in 143, rights holder system 144, rights holder database 144, and foreign exchange 160. In other embodiments, system 100b may not include all of the elements listed above and/or may include other elements in addition to and/or instead of those listed.

System 100b is a trading system in which tournaments may be played and which may also be used for trading currencies. In at least one embodiment, the Forex tournament of system 100b may be an online contest involving Foreign exchange trading via trading servers such as MetaTrader4 (MT4) or other similar trading platform. In at least one embodiment, the trading platform may include a trading server, a tournament server and a trading terminal.

Trading host 108 is a system, which may include one or more computers (each having a processor system of more one or more processors and memory system, and in input and/or output system), which hosts a trading server, which may be an MT4 server, for example. Trading host 108 may communicate with the user's system (i.e., agent resource 119 or player system 140) and/or with a different or additional web server. In this specification, any place where a server is mentioned the host system on which the server runs may be substituted and any place where a host system is mentioned the server that runs on the host system may be substituted to obtain a different embodiment. For example, any place that trading host 108 is mentioned the trading server may be substituted, and any place that the trading server is mentioned the trading host 108 may be substituted.

Trading host 108 may provide an interface, via which a player 104 may perform trades. Trading host 108 may include a graphical user interface, via which a user may interact with trading host 108 to place trades. Trading host 108 may receive trading requests from player systems. Trading host 108 may receive player data, such as the account balance, from the player database. Functions of the trading server on Trading host 108 may be called, via one more API calls, by a plug-in (e.g., a web or other software supplied by the tournament host for placing trades that are a part of a tournament).

Trading account 112 may be an account that is opened by a player for a particular tournament when a player signs up for a tournament. The player may sign up for the tournament on a remote system, such as agent resource 119, and the trading that occurs via trading account 112 may be monitored by the remote system, and the trading done via trading account 112 may be used to determine the progress of the tournament. In an embodiment, the tournament is conducted via agent resource 119, using information on the trading performing via trading account 112. Trading account 112 may also store a record of the entry fees deposited by the player and/or a record of the virtual funds being traded.

Trading server 114 may be an MT4 trading server (or other trading server) that allows player to trade different currencies. In an example, trading server 108 may be the product of MetaQuotes®. Trading server 114 may provide real time currency exchange rates from a foreign exchange. The trading server 114 may receive quotes from the quote source that trading server 114 is connected to and accordingly, at the moment of trade, it is clear which quotes are used for each trade. The quote source may be any source that provides these trading quotes (e.g., another trader that willing to trade the two currencies in question at the exchange rate specified in the quote). Trading server 114 may include server software for conducting Forex trades. For example, trading server 114 may include an MT4 server. Records of players 116 may include information about the players, including information about the trades and transactions made by players on trading host 108, and, optionally, the trading group of a particular player is associated with. The information stored in records of players 116 may include information that mirrors some of the information about the players stored in a database at the tournament host.

Web registration plug-in 117 may be software that plugs into a trading server, which handles communications between the tournament server and trading server. Web registration plug-in 117 may register user accounts for users to a tournament at the request of the tournament server, and web registration plug-in 117 may either allow or prevent users from placing trades as part of a tournament.

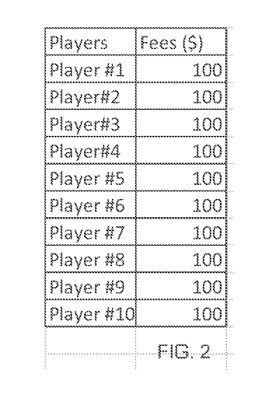

Network 118, (further discussed in conjunction with FIG. 2) may be any network or combination of networks of devices that communicate with one another, such as any combination of Wide Area Networks (WANs) (e.g., the Internet), Local Area Networks (LANs), Plain Old Telephone Systems (POTSs), and/or mobile device communications network. Trading host 108 receives, via network 118, requests for placing Forex trades, information about the trades, information about the tournament, and may gather and/or compute statistics about Forex trades and/or the tournament. Trading host 108 may communicate with the foreign exchange to receive real time currency exchange rates, via network 118.

Agent resource 119 may be a system of one or more machines (e.g., computer systems) that facilitates running a tournament on a currency exchange platform, such as MT4 or another Forex platform. Agent Resource 119 may be a web server or gaming server. Although trading host 108 and agent resource 119 illustrated in FIG. 1B as being different systems, trading host 108 and agent resource 119 may be the same system and/or machine. Agent resource 119 may facilitate running a licensed Forex tournament. In at least one embodiment, agent 106 may be the tournament administrator. The tournament administrator may manage the agent resource 119, which may be any system connected to network 118. Agent resource 119 receives registration information from one or more player systems, makes a decision to start and/or end a tournament, provides an interface to player systems and/or monitors player's accounts in order to collect various statistics about the tournament. Agent resource 119 may provide a webpage for the player, may poll trading host 108, and/or trading server 114 at intervals for updated tournament values and may store the account information of the players (in an embodiment polling trading host 108 and/or trading server 114 may be performed by polling a database maintained by trading host 108 and/or trading server 114). Agent resource 119 may be any portion of any system connected to a network (e.g., network 118).

Lobby 127 may display a list of tournaments with one or more current, future and/or past tournaments and for each tournament displayed may display the type of the tournament (e.g., the currencies involved, whether or not there is an entry fee, the type of distribution scheme used). Lobby 127 may also give an option to filter the list of tournaments based on the type or date of the tournament. Selecting a tournament may cause the tournament lobby 128 to be displayed.

Tournament lobby 128 may provide detailed information about a particular tournament, which may not be available at lobby 127. For example, players may take part in a tournament by selecting the ‘signup’ button in tournament lobby 128, thereby accepting all the terms and conditions of the tournament.

Tournament application 122 may be a website and/or internet accessible software application for online resources related to conducting tournaments. In an embodiment, tournament application 122 may be a web application running on agent resource 119. In at least one embodiment, tournament application 122 enables players to participate in Forex tournaments, provides statistical data on the Forex tournament. In at least one embodiment, tournament application 122 also provides statistical data to the right holder's database (e.g., database 146) in order to determine the profits resulting from the organization of tournaments by each of the users. Agent resource 119 may have features for providing a personal page to each player, which gives the player access to all of the functionality provided by the software of tournament application 122, such as the ability to participate in tournaments. The personal page of the player may be referred to as a personal office. In an embodiment, the personal account information and the data related to the tournaments a particular player has taken part in may be referred to as the personal office.

Agent resource 119 may show all of the available types of the tournaments, the statuses of the tournaments, and/or the number and positions of all of the players of the tournaments that are being conducted via the software of tournament application 122. A GUI may be associated with tournament application 122, which may have an appearance similar to a scoreboard on a stadium in that the game itself does not take place on the main page of the GUI (which is analogous to the scoreboard), but the main page of the GUI may show the results of the ongoing games at the current states of the games. The Forex tournament GUI may give a more detailed information about the course of the tournament.

In at least one embodiment, agent resource 119 runs the software of Tournament application 122, and agent resource 119 is an online resource or a website owned by the user that interfaces with the right holder's technology platform for holding investment tournaments. The Tournament application 122 may provide players with an opportunity to take part in investment tournaments. The agent resource 119 may, in conjunction with tournament application 122, provide statistical data on the investment tournament to the right holder's major database in order to control royalties received from one or more agents/users that are running investment tournaments. In one embodiment, tournament application 122, alone, may provide the statistical data on the investment tournament to the right holder's major database, and in another alternate embodiment, agent resource 119, alone, may provide the statistical data on the investment tournament to the right holder's major database. In at least one embodiment, tournament statistical data may be provided based on a specific filter and interval sample.

In at least one embodiment, a tournament application 122 may have a tournament lobby or home page that provides a player with a brief summary of the tournament including the type of tournament (e.g., Forex, the types of currencies exchanged, stock, bonds, other investment securities, etc.), contest duration, time of the tournament start, time of the tournament end, prize fund, amount of prize-winning places, total amount of players in the tournament. In an alternate embodiment, the tournament lobby and home page may be provided by agent resource 119, which may be running the software of tournament application 122. In at least one embodiment, a tournament application 122 may have a help section that provides a player with rules and information for taking part in trading tournaments. A directory or chart of past, current, and/or future trading tournaments may also be available in at least one embodiment of the tournament application 122. When a player selects a past tournament, statistical information about that tournament may be provided. When a player selects a current tournament, information about how to join the tournament and the rules of participation may be provided if registration is still open. If registration for a current tournament is closed, a button or link for current statistics for trading may return the time duration of the tournament, as well as the expected distribution of the prize fund. When a player selects a future scheduled tournament, the player may be provided with information about the tournament (such as the type of tournament, the duration of the tournament, the entry fee of the tournament, and/or information about the distribution of prize money, etc.) and an opportunity to register for the tournament. In at least one embodiment, the tournament chart may be provided with a tool with which player 104 may filter the tournament chart to display tournaments having specific criteria (tournament type, entry fee, duration, etc.). The tournament chart may be presented with tabs via which the player can see a particular tournament by clicking on a corresponding tab. In at least one embodiment, all of the tournaments in a tournament chart are displayed by default if no filters criteria are selected.

As mentioned above, in at least one embodiment, a tournament application 122 (and, alternatively, agent resource 119) may have a personal page also referred to as a “personal office” for each individual player that provides the player with individual and secure access to the investing tournament. Through the personal page, a player may sign up for tournaments, view personal statistics, such as finished tournaments, current tournaments, future tournaments, tournaments the players that won and/or took part in the tournament, and investment statistics on the positions the player is interested in. The personal page may provide the player with the ability to carry out financial operations in order to add funds to the player's tournament account and withdraw prize money from the player's tournament account. Financial operations may be carried out with electronic payment systems with the ability to automatically check the entry of funds in to the account in order to avoid the use of human resources for processing funding operations.

In at least one embodiment, a player may sign-up for a tournament by selecting a particular tournament with a “mouse click” (or a click form another pointing device) from a tournament table or pressing the “Sign Up” button in the tournament lobby that proclaims the desire and intention of the player to take part in the tournaments and accept all of the respective terms and conditions.

In at least one embodiment, once a player registers with the tournament application 122 to take part in a tournament, the player gains secure access to the tournament with a unique user ID—login and/or password that the player may enter on the player's personal page. Once a player is logged in, the player gains access to a trading terminal for conducting trades, and a contest account with a unique account number assigned for holding the player's investment funds. A trading terminal may be any software used for trading on an exchange. In at least one embodiment involving a Forex tournament, the trading terminal may be provided by a right holder 102, such as a MetaTrader 4 trading terminal. A player's contest account may be created via the player's MT4 account. In another embodiment, a player's account may be created on the trading host by an instruction sent from tournament application 122, and the player's account may be specific to a particular tournament. In the current embodiment, the player's account on the trading host is only available for use during the time a tournament is active. In at least one embodiment the trading terminal software may be downloaded to the player's computing device (which may be a client of the trading server 114 and/or tournament application 122), or the trading platform may remain resident on the tournament application 122 server.

The tournament administrator may be responsible for managing agent resource 119 and/or responsible for marketing the tournament. As mentioned above, agent resource 119 may include retrieve trading server data 130, tournament controller 132, personal accounts 134, and compute values 139, among other things. Any place that agent resource 119 is mentioned the tournament server may be substituted, and any place that the tournament server is mentioned the agent resource 119 may be substituted.

Player registration 124 registers players for participating in Forex tournaments. The registration process may call one or more API methods of the MT4 server plugin. In at least one embodiment, players may register with agent resource 119 by providing their full name and contact information, such as a phone number, country, and street address. During registration, the user may select a login identifier and password. In an embodiment, players may be able to login to agent resource 119 by using the login and password from tournament application 122.

Agent resource 119 may include a personal web page of the tournament player. Tournament application 122 may provide access to all of the functions of the Forex tournaments. In this specification, authorized player is a player who has signed into the Agent resource 119 using the unique user ID, which may be a login identifier and/or password. Agent resource 119 enables players to sign up for tournaments, receive statistics about previous tournaments, information about future tournaments, the status of the current tournaments, the rank of the player in current tournament. Agent resource 119 may provide the ability to carry out financial operations in order to add funds to the tournament account and withdraw prize money. In at least one embodiment, agent resource 119 may provide methods for depositing money for entry fees for tournaments, by using electronic payment systems with the ability to automatically check the entry of funds, in order to avoid manually processing operations related to transferring funds. Agent resource 119 may aid in automatically withdrawing funds from the same account that the deposit made into.

Database 129 may store each player's login identifier and password, trade requests, account balance, the one or more tournaments that the player is participating in currently, details of previous tournaments, rankings in previous tournaments, and associations of a player with a tournament server. In at least one embodiment, database 129 may reside on agent resource 119. In another embodiment, database 129 may reside on a separate system connected to the network 118.

Retrieve trading server data 130 is optional. Retrieve trading server data 130 may be an algorithm that retrieves data from trading host 108 (e.g., at regular intervals), which may receive updates of the tournament statistics and may store the values in agent resource 119. In other embodiments, trading host 108 may send updates of the tournaments without being queried or polled.

Tournament controller 132 decides when to start a tournament or close a tournament. In at least one embodiment, tournament controller 132 creates trading accounts on trading host 108, for each participant in registered for a particular tournament. The trading accounts may be linked to a fictitious financial institution from which fictitious funds are withdrawn and/or deposited as a result of the trades in the tournament (although fictitious banking accounts may have been provided by trading host 108 for demonstration purposes, the fictitious accounts were never intended to be used for conducting a tournament as disclosed herein). Trading accounts on trading host 108 facilitate the trading in a game tournament. The trading accounts are not activated until the start of the tournament. The accounts are grouped together in association with each of the individual tournaments created by tournament application 122. Players cannot trade before the start of the tournament. In at least one embodiment, tournament controller 132 may control the start and end time of the tournament. The end time may be determined based on some of, or all of, the number of trades, number of the players in the tournament, the goal of the tournament, the profit made in the tournament, and/or the duration of the tournament. Tournament controller 132 may determine the ranking of the players and the winners of the tournaments. After the end of a tournament, the accounts are blocked on trading host 108, but the player's accounts still exist on the tournament host. After the end of the tournament, these accounts are marked as “played out,” on the tournament host and are not further used. At the end of a tournament, the information in tournament lobby 128 may be updated. By opening and blocking the accounts with the start and end of the tournament, grouping the accounts together, and using accounts that are linked to fictitious banks, for example, trading host 108 may be used for running a tournament, even though trading host 108 was not designed to be a platform for tournaments. The other features provided along with tournament application 122, such as the lobby 127, tournament lobby 128, the tournament registration, and prizes, further converts the trading being performed on the trading host 108 into a tournament.

Personal accounts 134 stores the login and password for the account on agent resource 119, stores player information about the tournaments currently playing and past tournaments, the rank on the player in tournaments, prize money and other personal information.

Store tournament updates 138 may store values characterizing current tournaments, may store values characterizing past tournaments, may store the ranks of the players, may store the values of the prize money, and may store information about how the prize money is distributed amongst the players of a tournament.

Compute values 139 may compute updates to the tournament when a player request statistics. Compute values 139 may use information stored in store tournament updates 138 to compute the requested information and optionally may also compute the end of tournament values and rank players. In at least one embodiment, compute values 139 computes the prize money distribution. For example, compute values 139 may handle payment withdrawals and the processing of payments to the participants of the tournaments that have won a prize. Calculate values 139 may send payments to a rights holder that are due upon the completion of a tournament, as well as transfer of the data to the rights holder for that the rights holder may use to control the amount of the agent's income gained from holding Forex tournaments. Tournament controller 132 may invoke compute values 139 to determine when to end a tournament, distribution of funds, and/or the rankings of the players. Trading terminal software 141 may be software that is downloadable by the player for accessing trading host 108, and for performing trades and transactions on trading host 108. Terminal log-in 143 may receive a user name and/or password from a player 140, for connecting to trading host 108 to perform trades and transactions as part of a tournament. Rights holder system 144 receives statistical data on the Forex tournament from Agent Resource 119, in order to control profit received from the organization and holding of tournaments by of the users (i.e., each agent resource 119) of the rights holder's software (e.g., the tournament application 122). Rights holder database 146 stores the statistical data on the Forex tournaments run by agent resource 119, and may optionally store account information for each user (e.g., agent resource 119) of the rights holder's software. Calculate profits 148 may calculate the profits received by each organization running the software provided by rights holder system 144.

FIG. 1C is a schematic depiction of an example of the tournament gaming process using system 100b. FIG. 1C shows trading host 108, network 118, Agent Resource 119, and player systems 140a-c. In other embodiments, the gaming process may not include all of the elements listed above and/or may include other elements in addition to and/or instead of those listed.

FIG. 1C illustrates a scheme via which the tournament server and trading server interact. Trading host 108, network 118, and Agent resource 119 were discussed in conjunction with FIG. 1B, and player systems 140a-c are examples of player system 140 discussed in conjunction with FIG. 1B. Agent resource 119 may have a tournament and/or gaming server, which may be a separate application from the trading server on trading host 118. For example, the tournament application 122 may have a separate operation logic from the trading server 114. The trading server 114 may be an MT4 trading server (from MetaQuotes), which allows a user to make trades in a Forex. In essence playing in tournaments is the same as playing/trading in a MT4 server with the except that the trades of the game are supervised by the tournament server of agent resource 119 and no user (player) can take part in the tournament without the assistance of the tournament server of agent resource 119, for example. Essentially all interactions of the trading application and the trading server may include registration of the users in the trading server of trading host 118, and then further polling of the very same trading server 114 to determine the details of (e.g., the statistics of) a particular tournament. Communication/interaction with the trading server (e.g., trading host 118) may be performed by virtue of a plugin that uses the API provided by the trading server. In short, we can list the algorithm of the tournament server's and trading server's interaction actions.

### List of the Tournament Application and MT4 Trading Server Interaction

In at least one embodiment, no user can take part in the tournaments without registering in the tournament. For example, links for participating in the tournament (e.g., by placing trades that are used in determining the ranking of the player) may not be accessible to the user until after registering. The registration is performed by the tournament server calling, via web registration plug-in 117, the necessary API methods of the trading server.

2. Subsequently (after registration and starting a tournament), a tracking application (e.g., retrieve trading server data 130) tracks the tournaments, and when it is the time of start or end the tournament the tracking application opens or closes that particular tournament. In at least one embodiment, the start of a tournament is reflected in the ability to trade. In at least one embodiment, before the start of the tournament as well as after the end of the tournament, it is impossible to place trades that are related to the tournament. The tournament server keeps track of trading and allows trading for players registered in a particular tournament.
3. During the game and/or when the tournament is active, each player can view the statistics and see the transitory tournament results. The transitory results are available due to the tournament server polling the trading server 114 and/or querying a database of the trading host at particular intervals about the transactions performed. The tournament application calculates the results displayed based on the information obtained by polling the trading server or querying a database of the trading host 108.
4. After the closing of the tournament, tournament application gives a command to the trading server to close the gaming groups and cease trading. In an embodiment, trading is ended on trading 108 by the deletion or blocking of the accounts created on trading host 108 for a particular tournament. As soon as the command to close the tournament is processed, the final calculation of the particular tournament statistics begins. In at least one embodiment, all interactions between the tournament server and trading servers are conducted by means of the web registration plug-in 117. Trading itself is conducted without consideration of the gaming server, under a regular scheme through a client trading terminal, such as one of player systems 104a-c. After a particular tournament, the interaction of the tournament server and trading server related to that particular tournament stops.

Players may be ranked or rated (e.g. by compute values 139), based on the following ratios, a) a ratio of tournaments won to the number of players participating in the tournament; and b) a ratio of tournaments the players took part in to prize money won. Players may also be ranked on different types of tournaments, such as currency pairs and/or on the interval types of the tournaments (day, week, month). For example, the part of a player's rating may be a ratio of the number of tournaments of a particular type that the player played in to the number of tournaments of that type in which the player participated. Players may be ranked or rated based on any one of, or any combination of, the above ratios.

In at least one embodiment, compute values 139 may include software (e.g., scripts or other code) for statistical data processing (collection scripts) developed by right holder 102 may be available for both summarizing results and saving the results to a database for future reference and/or analysis. In this specification, the terms scripts, code, program, and software may be substituted one for another to obtain different embodiments.

In at least one embodiment, scripts for statistical data processing (collection scripts) may be deployed in a trading server (e.g. a MT4 server) and may support a platform for the tournament server 114 (e.g., an MT4 platform). The scripts may connect to trading host 108 at defined intervals. The scripts may gather login information about of all players signed up for tournaments and may process the statistics of players' trades and/or players' orders. In at least one embodiment, the scripts for collecting statistical data may be divided by hourly, daily, weekly, and/or monthly scripts according to the launching time and type of tournament being processed. In another embodiment, scripts may analyze data concerning the orders of a certain player and may form a table tracking the relative values of currencies of a certain currency pair (for a Forex tournament) and/or may form a table tracking the values of currencies of an investment instrument. The tables formed may cover a particular finite period of time and/or may be continually updated and maintained.

In at least one embodiment, scripts may also be employed that provide data for agent resource 124, and the forming scripts are divided by types (such as contest interval, and/or currency pair).

In at least one embodiment, scripts may query and/or transfer financial and tournament data between one, more, or all of tournament application 122, agent resource 119 and rights holder 144, to determine fees due to the right holder 102 from the user/agent 106 based on the fees collected from players by the agent 106.

In at least one embodiment of the trading tournament, the formation of the prize fund depends on the type of the tournament. If the trading tournament is a “freeroll” competition, the agent 106 is responsible for the prize fund formation. If the tournament is paid, a player pays an entry fee (which optionally may be a nominal fee) to enter the tournament, and the prize fund is formed from the total amount of the players' deposits (less user/agent 106 commission) made until the registration for tournament is closed. In at least one embodiment, the registration may be closed at the beginning of the tournament. In an alternative embodiment, registration may end after the tournament begins. The following formula describes the prize fund formation without taking into consideration the agent 106 commission taken from the prize fund:

$$y = {x}_{i} + {x}_{i + 1} + … + {x}_{n} or y = {\sum }_{k = i}^{n} {x}_{k} \qquad ( Formula 1 )$$

Where y is the total prize fund, x is a deposit amount (equal to the nominal entry fee of the tournament the player takes part in) of i-th player, and n is the total number of players when registration for a particular tournament closes.

In at least one embodiment of trading tournaments, the distribution of prize fund may not depend on the type of the tournament, e.g., for “freerolls” and “paid” contests the same distribution formulas may be used (a freeroll is a tournament with no entry fee). The tournament prize fund for a particular tournament is distributed as a percentage of the total fund. The tournament does not depend on the algorithm of how the prize fund is distributed among the winners. Many different algorithms for distributing the prize fund may be used. Some principles that may be used in determining a specific algorithm for distributing the prize fund are as follows. In at least one embodiment, only a part of the players get prizes, so that the first prize winner receives more money than the first prize winner's original contribution (for example: if only two players take part in the particular tournament, only one of them will get a prize).

In at least one embodiment, the number of prize winners may vary with each game, and may depend on the total number of players. For example, if the number of the players is two, there will be just one winner. If 1000 players take part in the tournament, there may be 300 winners (or another number of winners that is less than 1000, but few enough so that the first prize winner and or other prize winners win an amount that is larger than the contribution to the prize fund made by the individual players.

In at least one embodiment, the higher the player ranks in the rankings, the higher reward that player receives. For example, in at least one embodiment, the player that ranks second may not get a larger prize than the player that ranks first. In at least one embodiment, every prize winner gets more money than the initial entry fee.

In at least one embodiment, the prize fund after the deduction of the commission is completely distributed between all of the prize-winners, regardless of the number of winners.

Prize money may be distributed to players of the trading tournaments of embodiments as follows. The number of prize-winning places and the reward for each place in a final ranking of tournament players are defined in advance of a tournament and in accordance with rules that are furnished to players during contest registration. Also the percentage of the prize fund available for distribution to players is also defined in the contest rules (90% in the example above). The number of prize winners, and the percentage distribution of prize money to prize winning players may be defined by the right holder 102 or the user/agent 106. When a player takes a prize-winning place, the player receives money in the amount of the reward for a certain place, without taking into account the money the player paid for participation in the trading tournament. In at least one embodiment if a player fails to win a prize-winning, the amount paid for participation in the tournament will not be returned to the player.

Continuing with the example of Table 1, suppose that the first place or “grand prize” winner gets twenty five percent (25%) of the total fund. In this instance, player number 1 (that takes first place) gets a reward equal to $250 (i.e., 25% of $1000). Thus, all of the other players who took prize-winning places will get a certain percentage of the remaining prize fund.

In at least one embodiment, the count of the number of prize-winners does not include the grand prize winner. In other words, if a tournament has 50 players or contestants and 15 prize-winners, the prize-winners are the contestants with place numbers from 2 to 16 inclusive (e.g., the 15 prize winners are the second place winner, third place winner, . . . , and sixteenth place winner).

For an embodiment where a user/agent 106's commission percentage of a prize fund is set by the right holder 102 or user/agent 106 at ten percent (10%), the commission is deducted from the total prize fund. Thus, the initial meaning of the prize fund is defined by Formula 2:

k=(xₙ*10)/100

x=xₙ−k

Where k is the commission, xₙ is the initial prize fund before deduction of the commission, and x is the prize fund that will be divided between the players (including the first place or grand prize winner) who took the prize places, the prize fund after deduction of the commission. More generally, let P_{commission} be the percentage of the commission expressed as a fraction (e.g., 10% is 0.1, 50% is ½, etc.), the formula 2 may be written as k=xₙ*P_{commission}, and as above x=xₙ−k. Next, the tournament winner (first place or grand prize winner) is deducted from the prize fund as defined in Formula 3:

y=x−(x*p/100) (Formula 3)

Where y is a net prize fund or residual prize fund remaining after tournament winner's reward has been deducted from the initial prize fund x, that will henceforth be distributed among the other prize winning contestants, and p is the percentage of the initial prize fund the first place or grand prize winner gets.

The descending winning percentages for the players who placed or ranked high enough to win a prize is determined as follows after deducting the grand prize from the prize fund using contestant weights. A contestant weight is the percentage of the net or residual prize fund that a contestant receives. In order to calculate the contestant weight, the total weight of all of the contestants winning the prizes is calculated first using Formula 4 as follows:

W_{c}=ΣᵢⁿWᵢ (Formula 4)

where W_{c} is the total weight of all of the contestants winning the prizes (excluding the first place or grand prize winner), Wᵢ is the weight of a particular player, i, and n is the upper limit of the number of the prize winning players, which in the example is 15 players, and so n is 15. Next the weight of a specific contestant Wᵢ is determined using Formula 5 as follows:

Wᵢ=y/(W_{c}*i) (Formula 5)

Where y is a “net” prize fund (prize fund−first prize), W_{c} is the total weight of all contestants winning the prizes, i is a certain player (this variable is iterative), for example, player number 2.

The money equivalent of a certain player reward is calculated by the following formula (Formula 6):

Pᵢ=Wᵢ*x/100 (Formula 6)

Where Pᵢ is the money equivalent of the reward, Wᵢ is the weight (percentage) of a certain player, and x is the total prize fund.

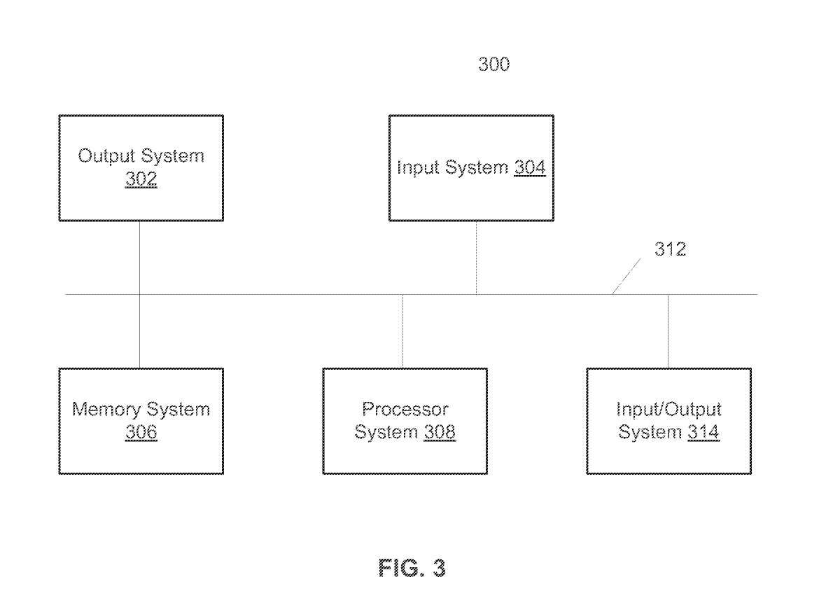

Player system 140 is a user system, which may connect to a network via a trading terminal software, such as trading terminal software 141. For example, player system 140 may be a personal computer, mobile phone, handheld computer, laptop, tablet computer, a television that is enabled to communicate with a network, such as a WAN, and/or another network appliance (a network appliance is any device or system that sends and receives messages over a network). In at least one embodiment, player system 140 may include an http client (e.g., a browser) for interfacing with the host system (see FIG. 3 for a further discussion of the host system), but may include an equivalent means of accessing and interacting with webpages. In an embodiment, the player may need to have a Forex account.

Trading terminal 142 may be any software used for trading on a trading server, the exchange or holding Forex tournaments such as MetaTrader4® (MT4) and/or the terminal of the Meta Quotes®.

Foreign exchange 160 is a foreign exchange for the trading host 108 to access when real time currency exchange rates are required. Foreign exchange 160 is a decentralized (e.g. over-the-counter) financial market for the trading of currencies, which determines the relative values of different currencies.

FIG. 2 shows a table of an example of forming a prize fund. In the example embodiment of a tournament with a $100 entry fee and consisting of 10 players, which according to formula 1 above, results in the total prize fund formed being $1000.

FIG. 3 shows a block diagram of a machine 300 used in system 200. The machine 300 may include output system 302, input system 304, memory system 306, processor system 308, communications system 312, and input/output device 314. In other embodiments, machine 300 may include additional components and/or may not include all of the components listed above.

Machine 300 may be an example of a system that may be used for any of the computers of trading host 108, agent resource 119, player system 104, rights holder 144 and/or one or more machines of foreign exchange 160.

Output system 302 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example.

Input system 304 may include any one of, some of, any combination of, or all of a keyboard system, a keypad system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. Input system 304, may include an antenna and/or wireless card for making phone calls, linking to local area networks, and/or connecting to a wide area network, such as a telephone system and/or the Internet.

Memory system 306 may include, for example, any one of, some of, any combination of, or all of a long term storage system, such as a hard drive; a short term storage system, such as random access memory; a removable storage system, such as a floppy drive or a removable drive; and/or flash memory. Memory system 306 may include one or more machine-readable mediums that may store a variety of different types of information. The term machine-readable medium may be used to refer to any medium capable carrying information that may be readable by a machine. One example of a machine-readable medium may be a computer-readable medium. Memory system 306 may store one or more machine instructions for implementing the monitoring system, the interface for the developers, an operating system and/or the reports. Memory system 306 stores machine instructions specific to the system (which is different depending upon whether system 300 is mobile, iPad, laptop, or other internet device and whether system 300 is being used as host system 100, the developer's system, or the end-user's system). For example, memory system 306 may include mobile phone applications such as software for storing and recalling phone numbers. Memory system 306 may include any of the trading account 112, trading server 114, player records 116, and/or registration plug-in 117 if machine 300 is trading host 108. Memory system 306 may include any of the database 116, tournament application 122, player registration 124, personal office 126, lobby 127, tournament lobby 128, retrieve trading server data 130, tournament controller 132, personal accounts 134, store tournament updates 138, compute values 139, and/or software 141 if machine 300 is agent resource 119. Memory system 306 may include trading terminal 142, if machine 300 is trading terminal 142, trading interface 110, and terminal login 143. If machine 300 is a machine of right holder system 144 memory 306 may store database 146 and/or calculate profits 148. Memory 306 may also store machine instructions for the methods discussed below.

Processor system 308 may include any one of, some of, any combination of, or all of multiple parallel processors, a single processor, a system of processors having one or more central processors and/or one or more specialized processors dedicated to specific tasks. For example, processor system 308 may include one or more Digital Signal Processors (DSPs) in addition to or in place of one or more Central Processing Units (CPUs) and/or may have one or more digital signal processing programs that run on one or more CPU. Processor system 308 implements the instructions stored in memory system 306.

Communications system 312 communicatively links output system 302, input system 304, memory system 306, processor system 308, and/or input/output system 314 to each other. Communications system 312 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 314 may include devices that have the dual function as input and output devices. For example, input/output system 314 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 314 may be optional, and may be used in addition to or in place of output system 302 and/or input device 304.

### Tournament Server Method of Trading Tournament

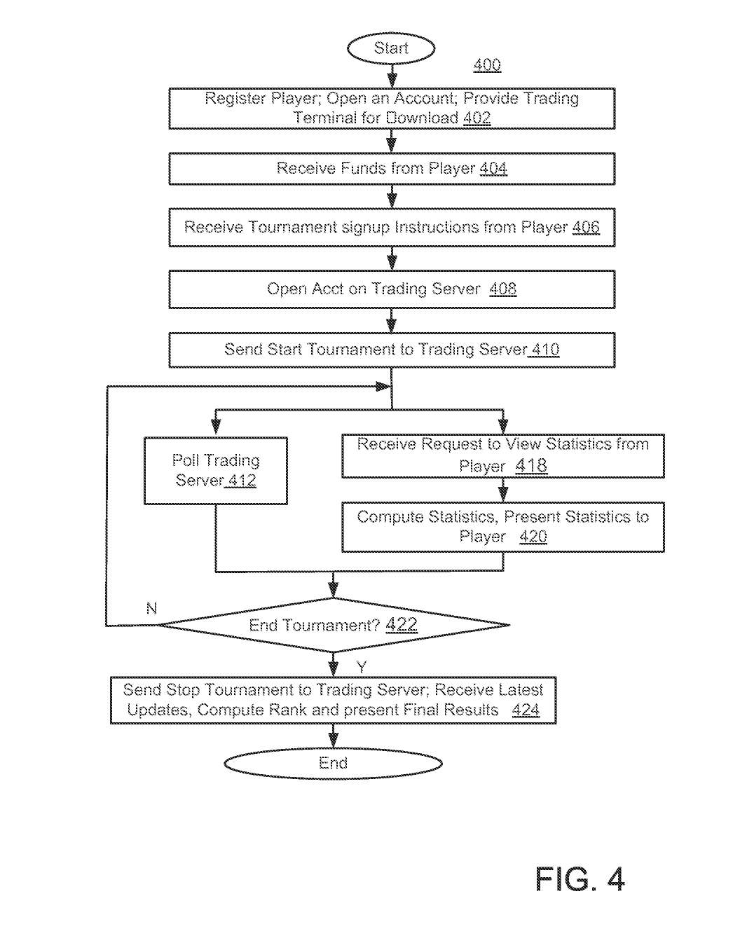

FIG. 4 shows a flowchart of method 400, an embodiment of a game server side method of trading tournament. Method 400 may be implemented by trading host 108. Machine instructions for method 400 may be stored in memory 306 (FIG. 3) if machine 300 is agent resource 119.

In step 402, player registration 124 receives a request to register a player. Registration includes opening an account on agent resource 119, establishing a personal webpage for the player on agent resource 119, and establishing player's personal accounts 134 for holding the player deposits for entry fee and receiving prize money. Step 402 may also provide a link to download trading terminal software 141, install trading terminal 142 on player system 140.

In step 404, agent resource 119 may facilitate the receiving of funds from player system 140 and deposit funds in the player's personal accounts 134 so that the player can participate in future tournaments. In at least one embodiment, if a player decides to take part in an entry fee based tournament and signs up for the tournament, the entry fee amount may be deducted from the personal account. In an embodiment, the fee may be used by agent resource 119 as a prerequisite to creating a trading account on trading host 108. In at least one embodiment, the personal accounts 134 have virtual funds and the player performs trading operations using the virtual funds. In at least one embodiment, if a player wins the prize in a tournament, the prize amount is added to the player's personal account and may further be withdrawn or used for opening a live trading account, or conducting trades via a live trading account.

In step 406, a player may sign-up for a tournament by selecting a particular tournament in Lobby 127 or selecting the “Sign Up” button in the tournament lobby 128 that indicates the desire and intention of the player to take part in the tournaments and accept all of the respective terms and conditions.

In step 408, if the user does not have an account for the tournament on trading host 108, agent resource 119 opens an account on trading host 108 for the player with an initial deposit. Step 408 may provides a login and password to the player so that the player can login in to trading host 108 to perform the trades.

For example, a player opens an account with agent resource 119 and deposits 1,000 USD (step 404). When the player decides to take part in a tournament with the nominal entry fee 100 USD, 100 USD will be deducted from the player's personal accounts 134 with agent resource 119, thereby having 900 USD remaining in the account (step 408).

For example, when a player signs up for a tournament, an account is opened with a initial deposit of 10,000 USD of virtual money. The Forex trading operations are performed using the trading account 112 account, and the results of the trading take part in the ranking. If a player wins the tournament and gets a prize in the amount of, for example, 150 USD, the prize amount is added to the player personal account (900+150=1050 USD). If a player does not take a prize-winning place, the balance of his personal account stays at 900 USD.

In another embodiment, when a player registers for a tournament, the agent resource 119 automatically opens a live trading account with agent resource 119, which may be suitable for broker companies or dealing centers. Further, the player may perform trading operations with the real money in the Forex market on the live account. In an embodiment, the tournament may be conducted on a server which also contains real accounts (i.e. an account via which people utilize real money), where their funds are accrued, in addition to the tournament type accounts. The essence of the division is to avoid excessive load since some trading server software (e.g., MT4 trading servers) is not necessarily optimal, and may have glitches and system crashes, etc. accordingly, the tournament accounts may be placed on a separate server. Routing, or to be precise the mechanism for routing is realized on the basis of a trading server, such as an MT4 trading server. Routing functionality is embedded into the software of trading host 122. In another embodiment, the player may sign up for the tournament, and the entry fee amount may be deducted from the live trading account. The tournament trading may be performed using a virtual account. If a player wins the prize in the tournament, the prize amount is added to the player's live trading account.

In step 410, tournament controller 132 may send information to trading host 108, via a web registration plugin 117, to start a tournament. The decision to start a tournament may depend on one or more of but not limited to the type of tournament, the trading amount, the number of players signed up play the tournament and the time elapsed since the tournament became available for signup.

In step 412, once the tournament starts, players can participate in trading, and Retrieve trading server data 130 polls trading host 108 retrieving updates on the tournament and stores the values in tournament update 138, until the tournament stops. In at least one embodiment, step 412 is performed at regular intervals until the tournament finishes. In step 413, compute values 139 computes information about the tournament based on the statistics collected during step 412.

In step 418, player system 140 can place a request to view the tournament status via Tournament application 122. In step 419, agent resource 119 sends a webpage (e.g., a webpage from tournament lobby 128) with information about the tournament.

In step 422, the tournament controller determines whether to end the tournament. If tournament controller 132 decides to continue the tournament, method 400 proceeds to steps 412 and 418.

In step 424, method 400 may send stop signal to the trading host 108, values may be updated with the end of tournament values, compute 139 may calculate the rank and final results. In an embodiment, “stop signal” may be a request to block or delete the player trading accounts that were created on trading host 108 for a particular tournament. The rank in the tournament, how a player traded and details of the trade may be displayed in tournament application 122 of the individual players or tournament lobby 128. Method 400 may also update the personal accounts 134 of the players receiving a prize. Method 400 may also update the personal accounts 134 of players that did not receive a prize, including statistics on the player's performance, ranking, losses or other information related to the details of a particular tournament.

In at least one embodiment, each of the steps of method 400 may be a distinct step. In other embodiments, method 400 may not have all of the above steps and/or may have other steps in addition to or instead of those listed above. The steps of method 400 may be performed in another order. Subsets of the steps listed above as part of method 400 may be used to form their own method. In at least one embodiment, there could be multiple instances of method 400.

### Trading Server Method

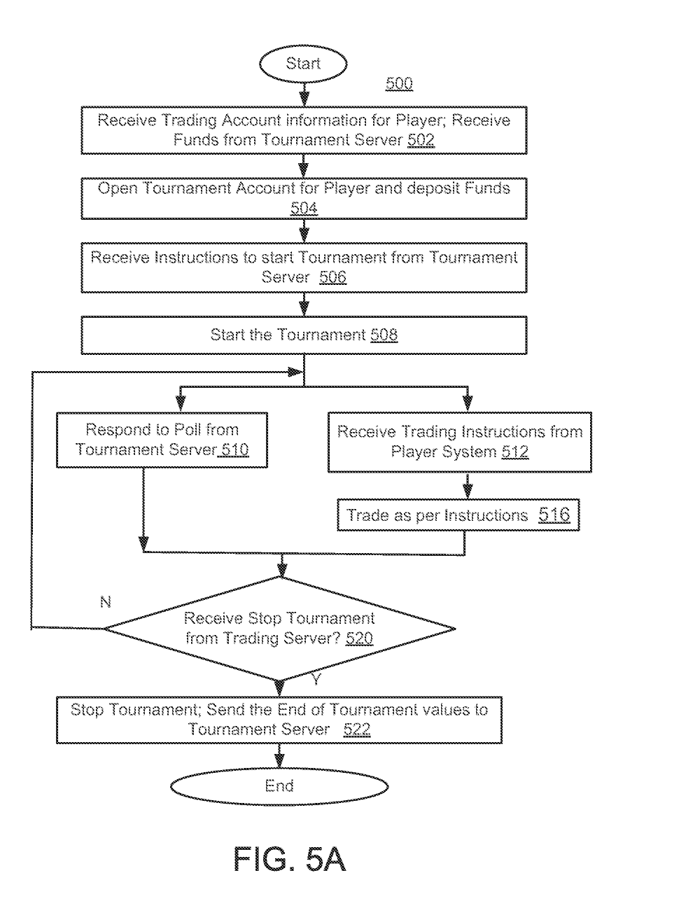

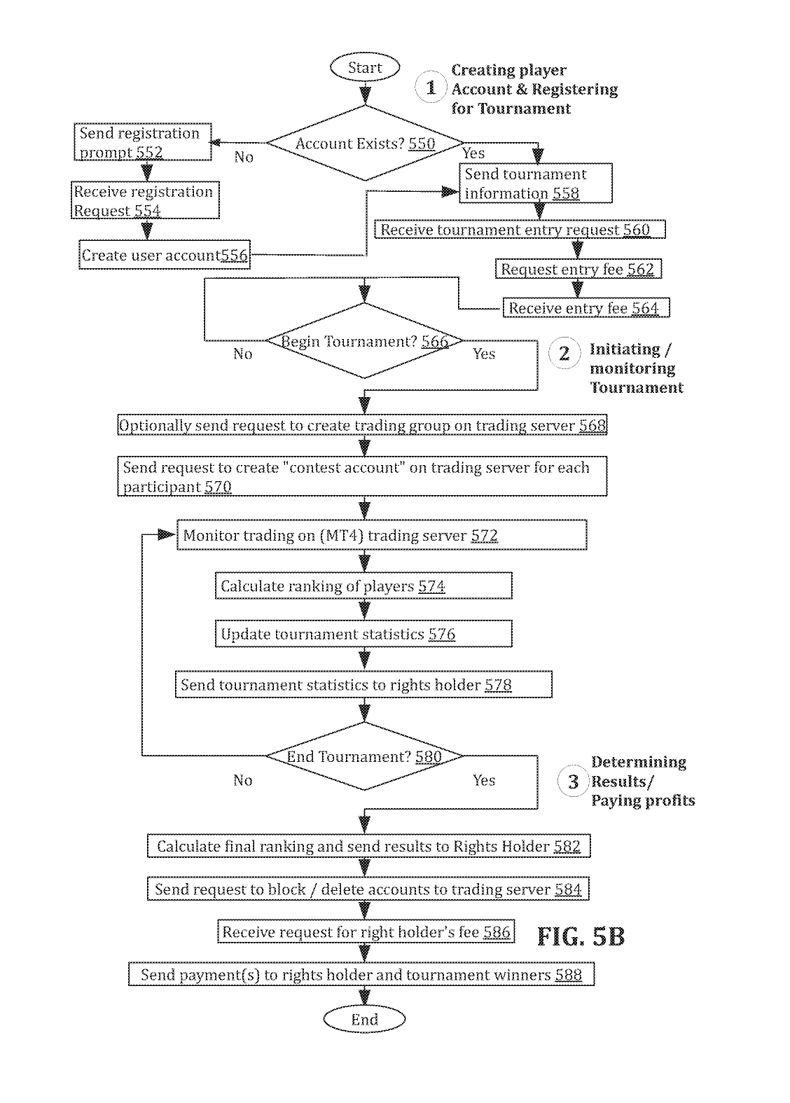

FIG. 5 shows a flow diagram of an embodiment of a trading server side method of trading tournament. Machine instructions for method 500 may be stored in memory 306 (FIG. 3) if machine 300 is trading host 108. In step 502, trading host 108 may receive instructions to open a trading account from agent resource 119. The trading account may be opened when a player signs up to play a tournament. Trading host 108 may also receive funds for the player.

In step 504, trading host 108 opens an account for the player and deposits the funds in the trading account of the player. The funds in the trading account may be used to trade during the tournament.

In step 506, trading host 108 may receive instructions to start a tournament from agent resource 119.

In step 508, trading host 108 opens the trading tournament by enabling players to login to the trading account and trade Forex related to a tournament.

In step 510, trading host 108 allows agent resource 119 to retrieve information about the tournament. Optionally, agent resource 119 may request the information, and trading host 108 may send the information. Step 510 may be repeated until the tournament finishes.

In step 512, trading host 108 may receive trading instructions from player system 140.

In step 516, trading host 108 may make Forex trades as per the instructions received in step 512. Trading host 108 communicates with Foreign Exchange 160 to get the latest Forex values.

Method 500 checks whether the trading host 108 has received the stop tournament from agent resource 119. If the trading server does not receive stop tournament, method 500 proceeds to steps 510 and 512.

In step 520, trading host 108 stops the tournament, which prohibits players from placing Forex trades as part of the tournament and sends a request to stop the agent resource 119.

In at least one embodiment, each of the steps of method 500 may be a distinct step. In other embodiments, method 500 may not have all of the above steps and/or may have other steps in addition to or instead of those listed above. The steps of method 500 may be performed in another order. Subsets of the steps listed above as part of method 500 may be used to form their own method. In at least one embodiment, there could be multiple instances of method 500.

### Method of Tournament Application and Related Software

FIG. 5B shows a flow diagram of an embodiment of a server system-side method of implementing tournament application 122, which may be performed on a server system such as agent resource 119, or rights holder system 144. Prior to the beginning of method 550, tournament application 122 may post information about an upcoming tournament in lobby 127 or tournament lobby 128. In decision box 552 the tournament application 122 receives a request from a player system 104 for access to a tournament (e.g., to enter the tournament), and in response tournament application 122 determines whether an account exist at the agent resource 119 for that player. If an account does not exist, in step 552 a registration prompt is sent to the player system 104, which may ask the user to enter information into a webpage. In step 554, in response, a registration request is received from player system 104, such as by receiving the webpage sent, but filled-in, by the user, with requested information. In step 556, a user account is created for the user at agent resource 119.

Returning to decision box 552, if a determination is made that the user has an account at the at agent resource 119, control is passed to step 558. After step 556 or decision box 552, in step 558, tournament information is sent to the player system 104. In response (if the user decides to enter the tournament), in step 560, a request is received from user system 104 to enter the tournament. In step 562, a request is sent for the entry fee. In step 564, the entry fee is received (e.g., funds may be sent or retrieved from a user a bank account, which may be associated with the tournament account). Steps 552-564 may be repeated multiple times for each player that joins the tournament.

In step 566, a determination is made whether to begin the tournament. The determination may involve determining whether a certain time and/or date has arrived at which the tournament is scheduled to begin and/or determining whether more than a certain number of players have registered for the tournament. Step 566 may occur while more players are registering for the tournament (which may be simultaneously while steps 552-554 are being performed on behalf of multiple players). If a determination is made not to begin the tournament, step 566 is repeated until the conditions are met for beginning the tournament (e.g., the scheduled time has arrived). In step 568, a group may optionally be created on the trading server for accounts associated with the tournament. In step 570, a request is sent from the tournament application 122 to the trading server to create accounts for each player. If the accounts are grouped together, in an embodiment, the accounts may be grouped together after being created instead of first creating the group and then adding accounts to the group. In step 572, tournament application 122 begins monitoring trades that occur as part of the tournament. Step 572 may involve polling trading host 108 and/or querying a database maintained at trading host 108 for information about trades. In step 574, a ranking of the players is computed based on the trades monitored. In step 576, tournament statistics are updated. In step 578, tournament statistics are sent by tournament application 122 from agent resource 119 to right holder 146. Step 574 may be performed in any order with respect to steps 576 and 578 and/or concurrently with steps 576 and 578. In decision box 580, a determination is made as to whether to end the tournament, which may be involve determining whether a particular condition is met, such as whether a time and/or date has arrived. If it is determined not to end the tournament, steps 572-580 are repeated. If it is determined to end the tournament, in step 582, final results of the tournament are computed and sent to the right holder. In step 584, a request is sent to trading server 108 to block future trades by accounts associated with the tournament. In step 586, a request from the right holder for payment of fees is received at the agent resource 119, and in response in step 588, the agent resource 119 send payment. Step 584 may be performed in any order and/or concurrently with any of steps 582, 586, and 588. Method 550 may be performed for multiple tournaments simultaneously.

In at least one embodiment, each of the steps of method 550 may be a distinct step. In other embodiments, method 500 may not have all of the above steps and/or may have other steps in addition to or instead of those listed above. The steps of method 550 may be performed in another order. Subsets of the steps listed above as part of method 550 may be used to form their own method. In at least one embodiment, there could be multiple instances of method 550.

### Player System Method

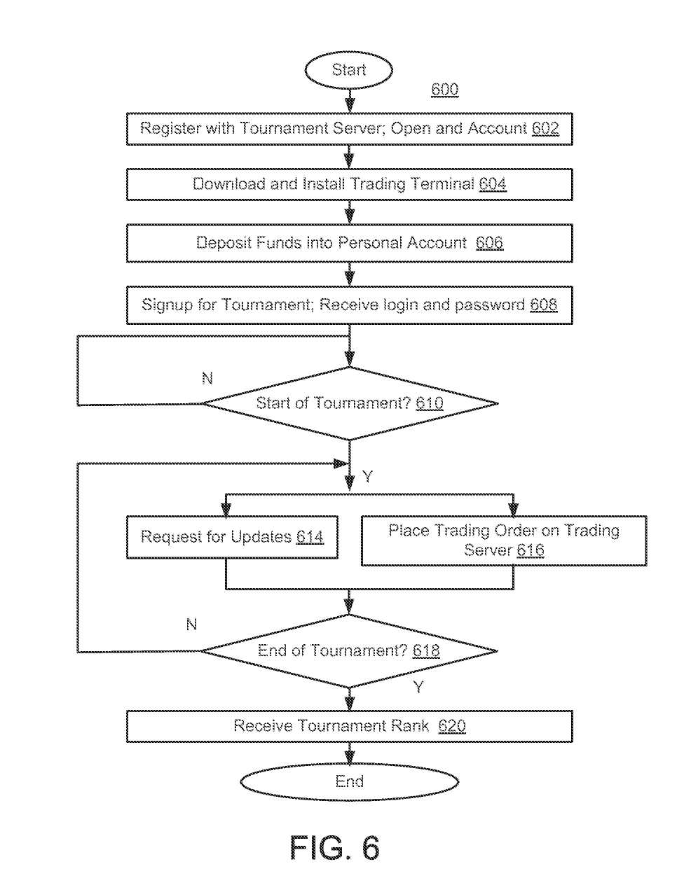

FIG. 6 shows a flow diagram of an embodiment of a player system-side method of trading tournament, which any be performed on player system 140. Machine instructions for method 600 may be stored in memory 306 (FIG. 3) if machine 300 is player system 140. In step 602, player system registers with agent resource 119 by providing personal information, login and password. Registration may include opening a personal account on the agent resource 119. If a player system is already registered, step 602 includes login into agent resource 119.

In step 604, player system 140 downloads and installs trading terminal such as MT4 Trading Terminal. Step 604 is optional, player system 140 may already have trading terminal 604 or player system may choose to install from a different location.

In step 606, player system 140 deposits funds into personal accounts 134. The funds in personal accounts 134 may be used to pay the fee for the tournament.

In step 608, player system 140 may select a tournament from lobby 127 and signup for a tournament on agent resource 119. Agent resource 119 opens an account for player system 140 on trading host 108 and provides the login and password for the trading account on trading host 108.

In step 610, method 600 checks agent resource 119 whether the tournament has started.

In step 614, player system 140 may make a request for an update to the tournament status at time when the tournament is still running (i.e., ongoing). Step 614 may be executed repeatedly as long as the tournament is in session.

In step 616, player system 140 may place a trading order on trading host 108 via trading terminal 142.

Steps 614 and 616 may be executed in parallel when the tournament is in session.

Method 600 checks if the tournament is in session in decision box 618.

In step 620, player system 140 receives a rank and end of tournament values form tournament server when the tournament finishes.

In at least one embodiment, each of the steps of method 600 may be a distinct step. In other embodiments, method 600 may not have all of the above steps and/or may have other steps in addition to or instead of those listed above. The steps of method 600 may be performed in another order. Subsets of the steps listed above as part of method 600 may be used to form their own method. In at least one embodiment, there could be multiple instances of method 600.

Although the steps of FIG. 5, FIG. 5B and FIG. 6 are, in some cases, depicted as occurring in sequence, the steps of FIG. 5, FIG. 5B and FIG. 6 may occur in parallel and/or different instances of the same application may run simultaneously.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

While the method and system for trading tournaments has been described by way of example and in terms of the specific embodiments, it is to be understood that the method and system for trading tournaments is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

Each embodiment disclosed herein may be used or otherwise combined with any of the other embodiments disclosed. Any element of any embodiment may be used in any embodiment. The methods and systems encompassed within this specification may also include embodiments that are only partially mentioned or alluded to or are not mentioned or alluded to at all in this brief summary or in the abstract.

1. A method comprising:
sending, from a tournament server to a trading server, a request create accounts on behalf of players to perform trades, the tournament server residing on a host system having a processor system including at least one processor and a memory system;
sending a message from the processor system of the tournament system to the trading system, to include an account of a player in a group of accounts at the trading system;
associating at the tournament server the group with a tournament;
the tournament server collecting information from the trading host about trades associated with the tournament;
determining, by the tournament host system whether a particular criteria is met; and
if the criteria is met, the tournament system sending a message to block trades by accounts associated with the group, therein terminating the tournament.

2. The method of claim 1, further comprising: the tournament server sending a message to the trading host to link the account of the player with a fictitious bank.

3. The method of claim 1, further comprising:
forming a prize fund;
providing an interface for the trading tournament; and
distributing the prize fund to the winners of the trading tournament.

4. The method of claim 1, further comprising establishing an account on the tournament server for the player.

5. The method of claim 3, the account on the tournament server being a persistant account that is not closed or blocked at the termination of the tournament.

6. The method of claim 1, further comprising collecting an entry fee; and forming a prize fund from the entry fee.

7. The method of claim 1, further comprising registering at least a player for an account on the trading tournament prior to sending a message for registering the a player.

8. The method of claim 7, signing the at least a player includes opening a trading account on a trading server and providing login and password to the at least a player.

9. The method of claim 8, the web interface includes one or more web pages for the at least a player registration.

10. The method of claim 8, the web interface includes one or more web pages for depositing entry fee in a personal account of the at least a player.

11. The method of claim 10, the web interface includes one or more web pages for tournament signup.

12. The method of claim 11, the web interface includes one or more web pages with tournament information.

13. The method of claim 11, the web interface includes one or more personal web pages for the at least a player.

14. The method of claim 11, the web interface includes one or more web pages showing the balance in the personal account of the at least a player.

15. The method of claim 11, the web interface includes one or more web pages showing the rank of the at least a player in the trading tournament.

16. The method of claim 1, wherein the trading competition is based on Forex trading.

17. A system comprising one or more machines comprising:
a processor system including one or more processors;
a storage system having one or more machine readable media, storing one or more instructions for implementing an application that includes one or more instructions that cause the processor system to perform a method including at least:
sending, from a tournament server to a trading server, a request create accounts on behalf of players to perform trades, the tournament server residing on a host system having a processor system including at least one processor and a memory system;
sending a message from the processor system of the tournament system to the trading system, to include an account of a player in a group of accounts at the trading system;
associating at the tournament server the group with a tournament;
the tournament server collecting information from the trading host about trades associated with the tournament;
determining, by the tournament host system whether a particular criteria is met; and
if the criteria is met, the tournament system sending a message to block trades by accounts associated with the group, therein terminating the tournament.

18. A machine readable medium storing one or more machine instructions for a web registration plug-in for running on a trading host, the trading host including a processor system having at least one process and a memory system, the memory storing a trading server;
the web registration plug-in includes machine instructions that
causes, by the processor system, the trading server to create an account on behalf of a player,
causes, by the trading host, the trading server to link the account to a fictitious bank account; and
causes, by the trading host, the trading server to block an account of a player after a tournament is finished.

19. The method of claim 18, the web registration plugin causes the server to group the account created with a group of accounts associated with a tournament.
